(19) United States
(12) Patent Application Publication
(10) Pub. No.: US 2006/0292319 A1
(43) Pub. Date: Dec. 28, 2006

(54) Printing tape and tape cartridge provided therewith

(75) Inventors: Hiroyasu Kurashina, Matsumoto-shi (JP); Miho Teshima, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION

(21) Appl. No.: 11/035,004

(22) Filed: Jan. 12, 2005

(30) Foreign Application Priority Data
Jan. 20, 2004 (JP) 2004-12283
Jan. 20, 2004 (JP) 2004-12284

(51) Int. Cl. B32B 33/00

(52) U.S. Cl. 428/32.64; 428/40.1

(57) ABSTRACT

A printing tape has a print-recording layer having a recording surface on a face thereof, and a transparent pseudo-laminating layer adhered to a back of the print-recording layer. The pseudo-laminating layer has a laminating adhesive-agent layer on a face thereof and a transparent tape layer on a back thereof, and is so arrange that the pseudo-laminating layer is reversed for adhesion to the face of the print-recording layer, thereby serving as a laminating tape for the recording surface. This printing tape is thus capable of laminating the print surface, after printing, with the printing tape itself.

### BACKGROUND OF THE INVENTION

1. Field of the Invention

This invention relates to a printing tape which is mounted or loaded on a tape printing apparatus as an object on which printing is made, as well as to a tape cartridge which is provided with the printing tape.

2. Description of the Related Art

Conventionally, there are two kinds of tape cartridges, one having contained a printing tape and an ink ribbon inside a cartridge case in a manner to be freely pulled out therefrom, and the other having contained a printing tape, a laminating tape and an ink ribbon inside a cartridge case in a manner to be freely pulled out therefrom. These two kinds of tape cartridges are respectively loaded into an exclusively used tape printing apparatus. In the former example, the printing onto the printing tape and the tape cutting are performed to thereby prepare a label. In the latter example, the printing on the printing tape, the adhesion of the laminating tape, and the tape cutting are performed to prepare a laminated printing tape.

In the latter example of the tape printing apparatus, it is possible to prepare a label without lamination by loading a tape cartridge in which the laminating tape is omitted. In the former example, on the other hand, there is no mechanism for adhering the printing tape and the laminating tape together. Therefore, even if a tape cartridge having added thereto the laminating tape is loaded, a laminated printing tape cannot be prepared.

### SUMMARY OF THE INVENTION

In view of the above-described problem, this invention has an advantage of providing a printing tape in which, after printing, the printing tape itself can be used to laminate the printed surface. This invention also has an advantage of providing a tape cartridge.

According to one aspect of this invention, there is provided a printing tape comprising: a print-recording layer having a recording surface on a face thereof; and a transparent pseudo-laminating layer adhered to a back of the print-recording layer. The pseudo-laminating layer has a laminating adhesive-agent layer on a face thereof and a transparent tape layer on a back thereof, and is so arrange that the pseudo-laminating layer is reversed for adhesion to the face of the print-recording layer, thereby serving as a laminating tape for the recording surface.

According to this arrangement, after having finished the printing on the recording surface of the print-recording layer, the user peels off the pseudo-laminating layer adhered to the back of the print-recording layer. He or she then turns the pseudo-laminating layer upside down and adheres it again to the face of the print-recording layer. It is thus possible to obtain a laminated printing tape.

According to another aspect of this invention, there is provided a printing tape comprising: a print-recording layer having a recording surface on a face thereof; a transparent pseudo-laminating layer adhered to a back of the print-recording layer; and a release tape layer adhered to a back of the pseudo-laminating layer. The print-recording layer has a recording tape layer on the face thereof and a general-purpose adhesive-agent layer on a back thereof. The pseudo-laminating layer has a transparent tape layer on a face thereof and a laminating adhesive-agent layer on a back thereof, and is so arranged that the release tape layer is released for adhesion of the pseudo-laminating layer to the face of the recording tape layer, thereby serving as a laminating tape for the recording surface.

According to this arrangement, after having finished the printing on the print-recording layer, the user peels off the pseudo-laminating layer adhered to the back of the print-recording layer together with the release tape layer. Then, the pseudo-laminating layer, once peeled off from the release tape layer, is adhered again to the face of the print-recording layer. A laminated printing tape can thus be obtained. Since the back of the print-recording layer is coated with the general-purpose adhesive agent, the printing tape can be adhered to an object (or a target) on which the laminated printing tape is to be finally adhered, in the same manner as an ordinary tape label.

According to still another aspect of this invention, there is provided a printing tape comprising: a print-recording layer having a recording surface on a face thereof; a release tape layer adhered to a back of the print-recording layer; and a transparent pseudo-laminating layer adhered to a back of the release tape layer. The print-recording layer has a recording tape layer on the face thereof and a general-purpose adhesive-agent layer on the back thereof. The pseudo-laminating layer has a laminating adhesive-agent layer on the face thereof and a transparent tape layer on a back thereof, and is so arrange that, upon peeling of the release tape layer, the pseudo-laminating layer is reversed for adhesion to the face of the print-recording layer, thereby serving as a laminating tape for the recording surface.

According to this arrangement, after having finished the printing on the recording surface, the user peels off the pseudo-laminating layer adhered to the back of the release tape layer together with the release tape layer. Then, he or she peels off the pseudo-laminating layer from the release tape and then turns the pseudo-laminating layer upside down to thereby adhere it again to the face of the print-recording layer. A laminated printing tape can thus be obtained. In addition, since the print-recording layer is coated on the back thereof with the general-purpose adhesive agent, the printing tape can be adhered to an object (or a target) in the same manner as an ordinary tape label.

According to yet another aspect of this invention, there is provided a printing tape comprising: a print-recording layer having a recording surface on a face thereof; and a transparent pseudo-laminating layer adhered to a back of the print-recording layer. The print-recording layer has a recording tape layer on the face thereof and a general-purpose adhesive-agent layer on a back thereof. The pseudo-laminating layer has a laminating adhesive-agent layer on a face thereof and a transparent tape layer on the back thereof, and is so arrange that the pseudo-laminating layer is reversed for adhesion to the face of the print-recording layer, thereby serving as a laminating tape for the recording surface. The general-purpose adhesive-agent layer and the laminating adhesive-agent layer respectively have a plurality of adhesive-agent coated portions and a plurality of adhesive-agent coating-free portions alternately disposed in a complimentary relationship with each other.

According to this arrangement, after printing on the recording surface of the print-recording layer has been finished, the user peels off the pseudo-laminating layer adhered to the back of the print-recording layer. He or she then turns the pseudo-laminating layer upside down and adheres it again to the face of the print-recording layer. It is thus possible to obtain a laminated printing tape. In addition, since the print-recording layer is coated on the back thereof with the general-purpose adhesive agent, the printing tape can be adhered to an object (or a target) in the same manner as an ordinary tape label. Further, since the general-purpose adhesive-agent layer and the laminating adhesive-agent layer have a plurality of adhesive-agent coated portions and a plurality of adhesive-agent coating-free portions alternately disposed on the tape surface, it is easy to peel off the print-recording layer and the pseudo-laminating layer. In addition, since there is no possibility that both the adhesive-agent layers come into contact with each other, both the adhesive-agent layers can be prevented from getting damaged.

According to still another aspect of this invention, there is provided a printing tape comprising: a print-recording layer having a recording surface on a face thereof; and a transparent pseudo-laminating layer adhered to a back of the print-recording layer. The print-recording layer has a cutting line formed substantially along a widthwise center of the printing tape so as to form two longitudinally extending halves, one of the halves forming a print-recording piece having the recording surface on the face and the other of the halves forming a cut-off piece. The pseudo-laminating layer has a laminating adhesive-agent layer on a face thereof and a transparent tape layer on a back thereof, and is so arranged that a substantial half, corresponding to a side of the cut-off piece, of the pseudo-laminating layer is folded for adhering onto the face of the print-recording piece upon removal of the cut-off piece, thereby serving as a laminating tape for the recording surface.

According to this arrangement, after having finished the printing on the face of the print-recording layer, the user cuts off the substantial half of the print-recording layer along the cutting line formed along the printing tape. Then, he or she folds the substantial half, corresponding to the side of the cut-off piece, of the pseudo-laminating layer over (or onto) the face of the print-recording piece which is the remaining half of the print-recording layer. It is thus possible to obtain a laminated print-recording tape. In this case, since the half of the pseudo-laminating layer is adhered, by means of folding, onto the print-recording piece of the print-recording tape layer, the positioning (or alignment) becomes easier. Deviation or distortion in position of the pseudo-laminating layer can be kept to a minimum.

According to still another aspect of this invention, there is provided a printing tape comprising: a print-recording layer having a recording surface on a face thereof; and a transparent pseudo-laminating layer adhered to a back of the print-recording layer. The print-recording layer has a cutting line formed substantially along a widthwise center of the printing tape so as to form two longitudinally extending halves, one of the halves forming a print-recording piece having a recording surface on the face and the other of the halves forming a cut-off piece. The pseudo-laminating layer has, as seen from the face side, a laminating adhesive-agent layer, a first transparent tape layer, a general-purpose adhesive-agent layer, and a second transparent tape layer. The second transparent tape layer has a cutting line formed substantially along a widthwise center thereof so as to form two longitudinally extending halves, one of the halves forming a transparent tape piece and the other of the halves forming a release piece, and is so arranged that a substantial half, corresponding to a side of the cut-off piece, of the first transparent tape layer and the transparent tape piece are folded, upon removal of the cut-off piece and the release piece, for adhering onto the face of the print-recording piece, thereby serving as a laminating tape for the recording surface.

According to this arrangement, after having finished the printing on the face of the print-recording layer, the user cuts off the cut-off piece, which is the half of the print-recording layer, along the cutting line formed on the printing tape. He or she also cuts off the release piece, which is the half of the second transparent tape along the back-cutting line which is formed substantially along the second transparent tape layer. Thereafter, the substantial half on the side of the cut-off piece of the first transparent tape layer and the transparent tape piece which is the remaining second transparent tape layer are folded onto the face of the print-recording piece which is the remaining recording tape layer. A laminated printing tape can thus be obtained. In addition, since the back of the recording tape layer has exposed thereto the general-purpose adhesive-agent layer, the general-purpose adhesive-agent layer enables the laminated printing tape to be adhered to an object (or a target), like an ordinary tape label. In this case, since the pseudo-laminating layer is adhered in a folded manner, the positioning becomes easier and, consequently, deviation or distortion in position of the pseudo-laminating layer can be kept to a minimum.

In the above-described arrangements, preferably, the laminating adhesive-agent layer has an adhesive-agent coated portion and an adhesive-agent coating-free portion disposed on a tape surface, and the adhesive-agent coating-free portion is formed in at least a part of both widthwise end portions of the printing tape.

In addition, preferably, the adhesive-agent coating-free portion is constituted by a plurality of longitudinally extending band portions which are parallel with a longitudinal direction of the printing tape, inclusive of widthwise both end portions thereof.

The adhesive-agent coating-free portion is preferably constituted by a plurality of bands which are inclined to the longitudinal direction of the printing tape and are parallel with each other.

The adhesive-agent coating-free portion is preferably constituted by a plurality of bands which are parallel with each other in the widthwise direction of the printing tape.

The adhesive-agent coating-free portion is preferably constituted by a plurality of isolated portions dispersed in a scattered manner.

At least part of adhesive-agent coated portions located at widthwise both end portions of the general-purpose adhesive-agent layer and the laminating adhesive-agent layer is preferably omitted.

According to the above arrangements, the laminated tape can be easily peeled off by utilizing the adhesive-agent coating-free portion as the starting point in the peeling operation. This arrangement is particularly useful in an example in which the pseudo-laminating layer is constituted by a thin tape material such as of polyethylene terephtalate (PET).

Preferably, the print-recording piece is formed slightly smaller in width than the cut-off piece.

According to this arrangement, the folded pseudo-laminating layer partly protrudes beyond the print-recording piece. The laminated printing tape can thus be adhered to an object of adhesion by means of the laminating adhesive-agent layer on this protruded part.

Preferably, the release piece and cut-off piece have printed thereon an operating instruction.

According to this arrangement, the user can easily prepare laminated printing tape without wrong adhering or cutting-off operation.

Preferably, the general-purpose adhesive-agent layer has an adhesive-agent coated portion and an adhesive-agent coating-free portion. The adhesive-agent coating-free portion is formed in at least part of widthwise end portions of the printing tape.

According to still another aspect of this invention, there is provided a tape cartridge comprising the above-described printing tape in a rolled state, and a cartridge case for containing therein the printing tape in a manner to be freely pulled out.

According to this arrangement, by mounting onto the tape printing apparatus the tape cartridge which contains therein the printing tape, there is provided a printing tape that can be laminated after printing.

### BRIEF DESCRIPTION OF THE DRAWINGS

The above and other objects and the attendant features of this invention will become readily apparent by reference to the following detailed description when considered in conjunction with the accompanying drawings wherein:

FIG. 1 is an external view of a tape printing apparatus on which a tape cartridge relating to an embodiment of this invention is loaded;

FIG. 2 is a plan view of a tape cartridge relating to the embodiment of this invention;

FIGS. 3A through 3C are sectional views of the printing tape according to a first embodiment of this invention;

FIGS. 4A through 4D are plan views showing adhesive-agent coated portions and adhesive-agent coating-free portions of the printing tape according to the first embodiment and a second embodiment of this invention;

FIGS. 5A through 5C are perspective views showing the procedure for preparing laminated printing tape by using the printing tape according to the first embodiment of this invention;

FIGS. 6A through 6C are sectional views of the printing tape according to the second embodiment of this invention;

FIGS. 7A through 7D are perspective views showing the procedure for preparing laminated printing tape by using the printing tape according to the second embodiment of this invention;

FIGS. 8A through 8C are sectional views of the printing tape according to a third embodiment of this invention;

FIGS. 9A through 9D are perspective views showing the procedure for preparing laminated printing tape by using the printing tape according to the third embodiment of this invention;

FIGS. 10A through 10C are sectional views of the printing tape according to a fourth embodiment of this invention;

FIGS. 11A through 11D are perspective views showing the procedure for preparing laminated printing tape by using the printing tape according to the fourth embodiment of this invention;

FIGS. 12A through 12C are perspective views showing adhesive-agent coated portions and adhesive-agent coating-free portions of the printing tape according to the fourth embodiment of this invention;

FIGS. 13A through 13C are sectional views of the printing tape according to a fifth embodiment of this invention;

FIG. 14 is a plan view showing the printing tape after cutting according to the fifth and sixth embodiments of this invention;

FIGS. 15A through 15C are perspective views showing the procedure for preparing laminated printing tape by using the printing tape according to a fifth embodiment of this invention;

FIGS. 16A through 16C are sectional views of the printing tape according to the sixth embodiment of this invention; and

FIGS. 17A through 17C are perspective views showing the procedure for preparing laminated printing tape by using the printing tape according to the sixth embodiment of this invention.

### DETAILED DESCRIPTION OF THE PREFERRED EMBODIMENTS

With reference to the accompanied drawings, a description will now be made in detail about a printing tape and a tape cartridge which contains or houses therein the printing tape based on the best mode of carrying out this invention. A description will also be made about a tape printing apparatus in which the tape cartridge is mounted or loaded. This tape printing apparatus is intended to print desired letters and characters on a printing tape which is mounted on the apparatus through the cartridge. The tape printing apparatus is also intended to cut the printed portion of the printing tape to a given length to thereby obtain a label.

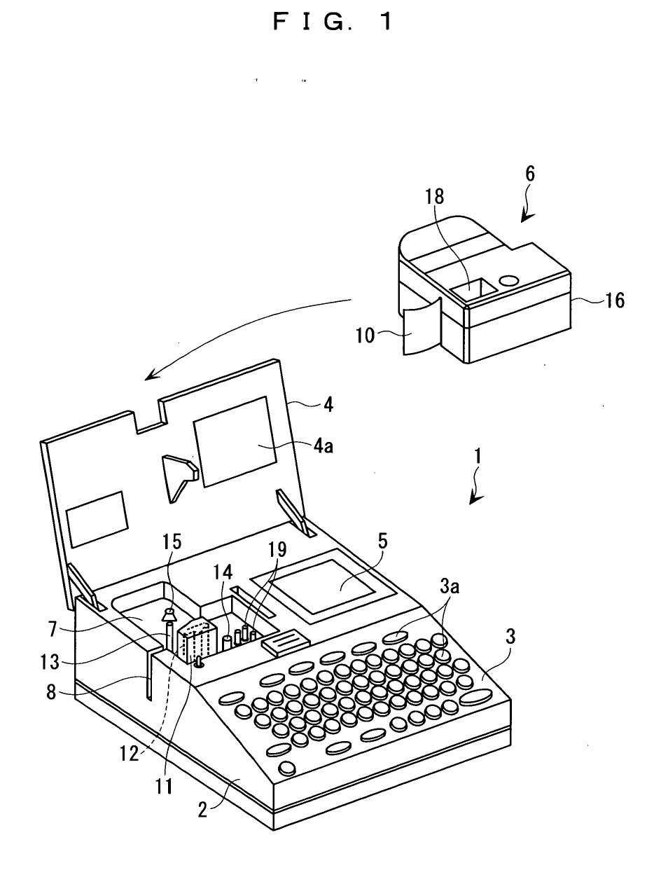

FIG. 1 is an external perspective view of a tape printing apparatus 1 with a lid open. As shown therein, the tape printing apparatus 1 has an external shell which is formed by an apparatus case 2 divided into an upper piece and a lower piece. A keyboard 3 having arranged therein various input keys 3a is disposed in a front upper surface of the apparatus case 2, and an opening and closing lid 4 is disposed in a rear upper surface thereof. Inside the opening and closing lid 4 are disposed a display 5, as well as a cartridge mounting block 7 for mounting therein a tape cartridge 6, in an embedded manner. The tape cartridge 6 is mounted in, or dismounted from, the cartridge mounting block 7 in a state in which the opening and closing lid 4 is left open. The opening and closing lid 4 is provided with a peep hole 4a for visually confirming the display 5 in a state in which the opening and closing lid 4 is kept closed.

On the left side of the apparatus case 4, there is formed a tape discharge opening 8 which communicates the cartridge mounting block 7 and the outside of the tape printing apparatus. A tape cutter (not illustrated) is arranged adjacent to this tape discharge opening 8 for cutting the printing tape 10 which is fed out. The printing tape 10 that has been printed is thus fed out of the tape discharge opening 8 and is cut off by the tape cutter.

The cartridge mounting block 7 is provided with: a printing head 12 having a thermal element covered with a head cover 11; a platen driving shaft 13 lying to face the printing head 12; a take-up driving shaft 14 for taking up an ink ribbon (to be described later); and a positioning projection 15 for aligning a tape reel 20 (to be described later). Under the cartridge mounting block 7, there is housed (though not illustrated) a tape feeding mechanism for rotating the platen driving shaft 13 and the take-up driving shaft 14. Further, cartridge detection switches 27 are disposed at a corner of the cartridge mounting block 7.

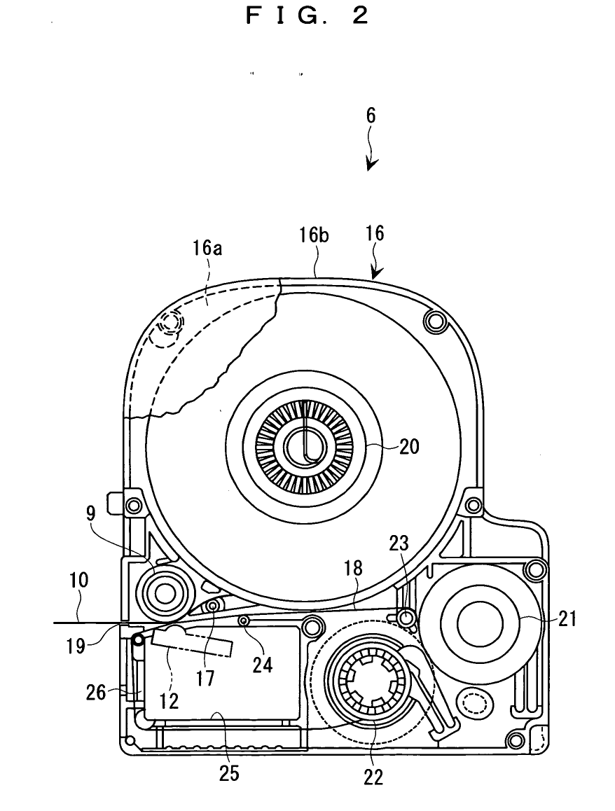

FIG. 2 is a plan view of a tape cartridge 6 in which an upper case is partly shown in section. As shown therein, the tape cartridge 6 contains the printing tape 10 and the ink ribbon in a respectively rolled state, inside a cartridge case 16 which is made up of an upper case 16a and a lower case 16b (“upper” and “lower” refers to the state as seen in FIG. 2). The tape cartridge 6 also contains therein a platen roller 9 which corresponds to the printing head 12. Inside the cartridge case 16, there are contained: a tape reel 20 around which is wound the printing tape 10; a ribbon winding reel 21 around which is wound the ink ribbon; and a reel 22 around which is wound the used ink ribbon.

On the other hand, the cartridge case 16 has formed therein, in close proximity to the platen roller 9, a substantially rectangular through opening 25 which penetrates the cartridge case 16 in a vertical direction. When a tape cartridge 6 is mounted into the cartridge mounting block 7, the printing head 12 faces this through opening 25 from the apparatus side so as to lie opposite to the platen roller 9. In this state, the platen roller driving shaft 13 and the take-up driving shaft 14 are engaged, from the apparatus side, with the platen driving shaft 13 and the take-up driving roller 14, respectively. In other words, the platen roller 9 and the ribbon take-up reel 22 function as driving reels, and the tape reel 20 and the ribbon winding reel 21 function as driven reels.

The printing tape 10 once rolled out of the tape reel 20 is guided by a tape guide pin 17 to the platen roller 9, where printing takes place and the printing tape 10 is fed out of a tape discharge opening 19. On the other hand, the ink ribbon 18 once rolled out of the ribbon winding reel 21 is guided by a first ribbon pin 23 and a second ribbon pin 24 to the platen roller 9, where the ink ribbon 18 is subjected to printing in a manner overlapped with the printing tape 10. The ink ribbon 18 further makes a U-turn guided by an opening wall which forms the through opening 25 and is taken up by the ribbon take-up reel 22. In this case, since the platen roller 9 and the ribbon take-up reel 22 on the driving side are driven in a manner synchronized with each other, the printing tape 10 and the ink ribbon 18 travel at the same time and printing on the printing tape 10 is performed while traveling. Then, the printing tape 10 fed out of the tape discharge opening 19 is cut by the tape cutter on the apparatus side, and is used as a label.

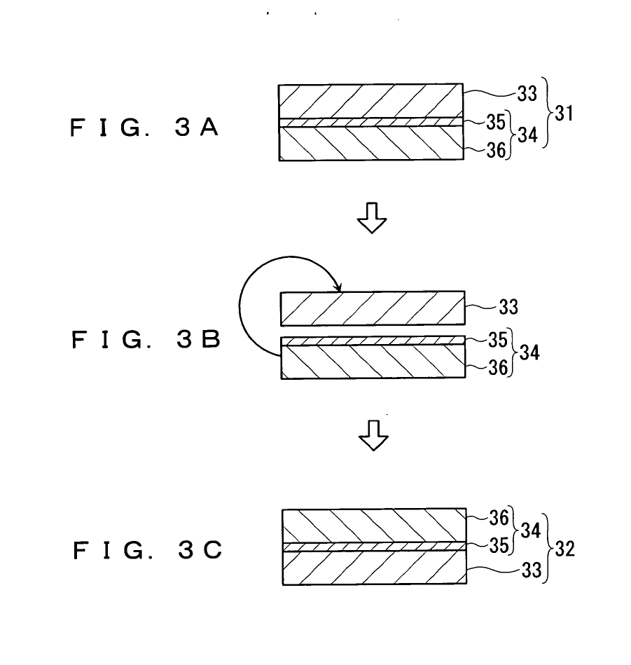

A description will now be made about a printing tape according to a first embodiment of this invention. As shown in FIG. 3A, a printing tape 31 is made up of: a print-recording layer 33 whose face (upper side as seen in FIG. 3A) serves as a recording surface; and a transparent pseudo-laminating layer 34 which is adhered to a back (i.e., a lower side, as seen in FIG. 3A, which lies opposite to the recording surface) of the print-recording layer 33. The pseudo-laminating layer 34 has a laminating adhesive-agent layer 35 on a face thereof (upper side as seen in FIG. 3A) and a transparent tape layer 36 on a back thereof (i.e., a lower side as seen in FIG. 3A). The term “print-recording layer” means a layer on which printing is made to keep the printed image as a record. The term “pseudo-laminating layer” means a layer which finally serves the purpose of a laminating layer but which serves, on the way, a temporary purpose other than that of the laminating layer. The upper side as illustrated in the relevant figures is normally referred to as “face” and the lower side as illustrated is normally referred to as “back” unless specifically defined otherwise.

The print-recording layer 33 and the transparent pseudo-laminating layer 34 are, respectively, made of a thin tape material such as polyethylene terephthalate (PET) or the like. The face of the print-recording layer 33 is subjected to a coating processing so as to improve the stay of the ink on the recording surface. This coating processing is the same in a second embodiment through a fourth embodiment which will be described hereinafter. Although not illustrated, there are prepared plural kinds of printing tape of different width.

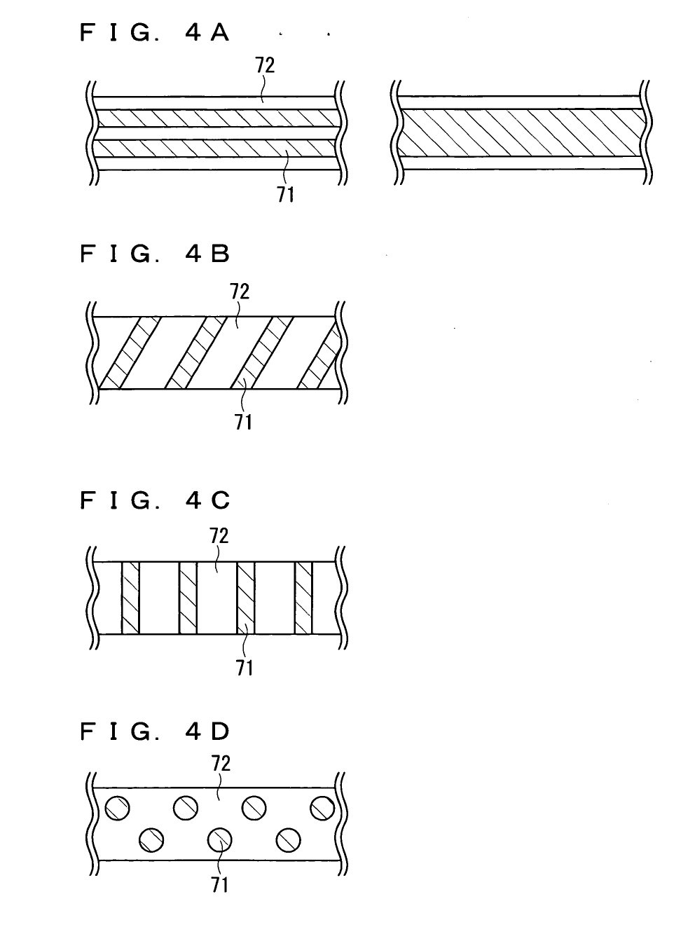

As shown in more detail hereinafter with reference to FIGS. 4A through 4D, the laminating adhesive-agent layer 35 which forms part of the pseudo-laminating layer 34 has on its surface an adhesive-agent coated portions 71 which are coated with an adhesive agent, and adhesive-agent coating-free portions 72 which are not coated with the adhesive agent. The adhesive-agent coating-free portions 72 are formed in at least part of the widthwise both end portions of the printing tape. As a result of this arrangement, by utilizing the adhesive-agent coating-free portions 72 as the starting ends in peeling operation, the pseudo-laminating layer 34 can be easily peeled off.

As the pattern for forming the adhesive-agent coated portions 71 and the adhesive-agent coating-free portions 72, the following examples may be listed. For example, in a stripe shape (FIG. 4A), the adhesive-agent coating-free portions 72 are arranged parallel with the longitudinal direction of the printing tape having the pseudo-laminating tape 34 and has a plurality of lateral bands inclusive of those formed in both widthwise end portions of the printing tape. In another stripe shape (FIG. 4C), the adhesive-agent coating-free portions 72. are arranged by a plurality of lateral bands which are parallel with the widthwise direction of the printing tape. In a polka dot shape (FIG. 4D), the adhesive-agent coated portions 71 are formed by a plurality of scattered island-like portions. In the above-described stripe shape as shown in FIG. 4C in which the adhesive-agent coating-free portions 72 are formed by a plurality of lateral bands parallel with the widthwise direction of the printing tape, the printing tape may sometimes be formed in which, depending on the position of cutting thereof, only a small amount of adhesive-agent coated portions remains. In order to avoid such a disadvantage, there may be employed still another stripe shape (FIG. 4B) in which the adhesive-agent coating-free portions 72 are constituted by a plurality of inclined bands which are inclined relative to the longitudinal direction of the printing tape and are also parallel with each other. The shape of the pattern to be employed may be other than the above-described examples; it is sufficient if the adhesive-agent coated portions 71 and the adhesive-agent coating-free portions are formed in at least part of both the widthwise end portions of the printing tape.

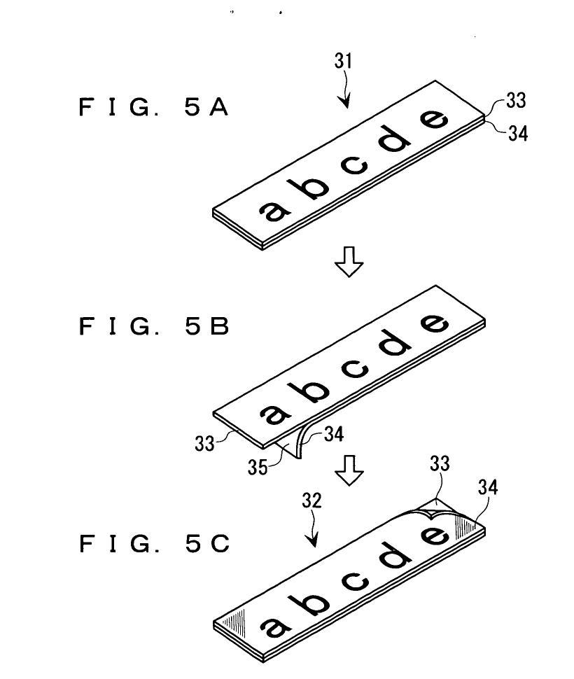

With reference to FIGS. 5A through 5C, a description will now be made about the procedure for preparing the laminated printing tape 32 by using the printing tape 31 of the first embodiment. The illustrated printing tape 31 has a character string “abcde” printed by the printing head 12 on the face of the print-recording layer and is cut to a desired length by means of a cutter (see FIG. 5A). The printing tape 31 having printed thereon a desired image is then subjected to peeling of the pseudo-laminating layer 34 off from the print-recording layer 33 (see FIG. 5B). Thereafter, the peeled-off pseudo-laminating layer 34 is reversed upside down (as seen in FIGS. 3B and 3C) so that the pseudo-laminating layer 34 looks down, and is then adhered, while keeping it in position, to the face of the print-recording layer 33 (FIG. 5C). Here, the terms “reversed upside down” and “looks down” are used with the example as seen in FIGS. 3A and 3B. As a result of the above-described operation, the recorded surface having printed thereon the character string “abcde” is laminated by the pseudo-laminating layer 34.

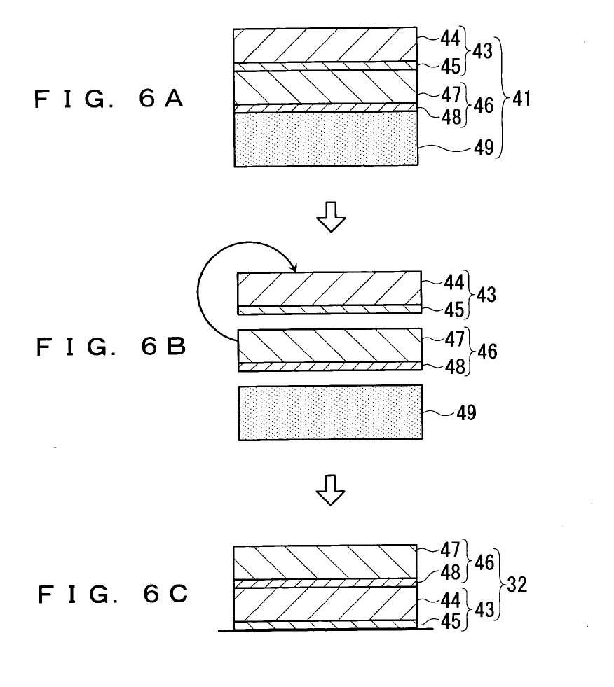

A description will now be made about the printing tape according to the second embodiment of this invention. As shown in FIG. 6A, a printing tape 41 is made up of: a print-recording layer 43 whose face serves as a recording surface; a transparent pseudo-laminating layer 46 which is adhered to a back of the print-recording layer 43; and a release tape layer 49 which is adhered to the back of the pseudo-laminating layer 46. The print-recording layer 43 has a recording tape layer 44 on its face and a general-purpose adhesive-agent layer 45 on its back, and the pseudo-laminating layer 46 has a transparent tape layer 47 on its face and a laminating adhesive-agent layer 48 on its back, respectively.

The release tape layer 49 is made of a piece of paper of fine quality whose surface is subjected to silicone coating. The laminating adhesive-layer 48 has, like in the first embodiment as shown in FIGS. 4A through 4D, an adhesive-agent coated portions 71 which have coated thereon the adhesive agent, and adhesive-agent coating-free portions 72 which are not coated with the adhesive agent. The adhesive-agent coated portions 72 are formed in at least part of the widthwise both end portions of the tape.

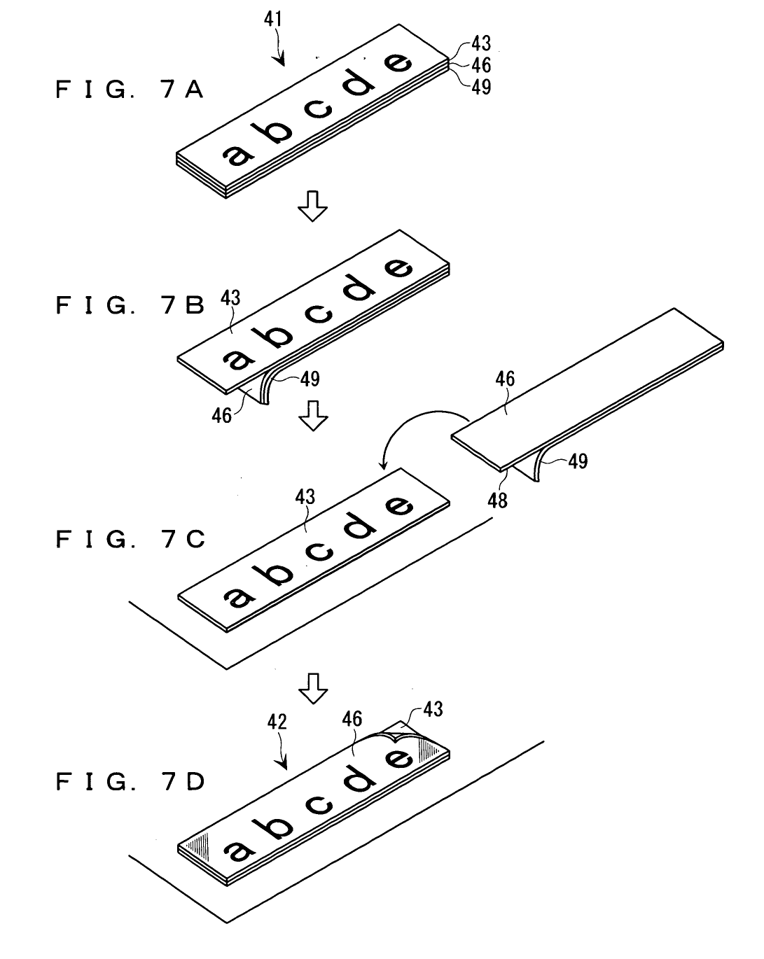

A description will now be made, with reference to FIGS. 7A through 7D, about the procedure for preparing the laminated printing tape 42 by using the printing tape 41 according to the second embodiment. The printing tape 41 shown in FIG. 7A has printed on its face a character string of “abcde” by means of the printing head 12, and is cut to a desired length by means of a cutter (FIG. 7A). In this manner, the printing tape 41 having printed thereon a desired image is subjected to peeling of the pseudo-laminating layer 46 together with the release tape layer 49 (FIG. 7B). Then, the release tape layer 49 which is adhered to the back of the pseudo-laminating layer 46 is peeled off from the peeled pseudo-laminating tape layer 46 (FIG. 7C). Finally, the peeled pseudo-laminating layer 46 is adhered, while keeping it in position, to the face of the recording tape layer 44 (FIG. 7D). As a result, the face of the print-recording layer 43, i.e., the recording surface having printed thereon the character string of “abcde” is laminated by the pseudo-laminating layer 46. Further, by exposing the general-purpose adhesive-agent layer 45 which is provided on the back of the print-recording layer 43, printing tape 41 can be adhered to an object of adhesion like an ordinary tape label.

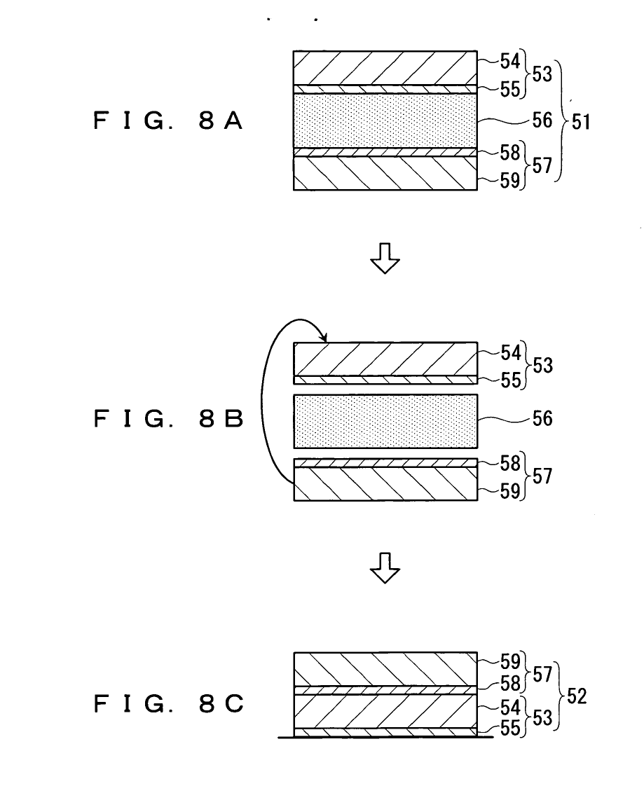

A description will now be made about the printing tape according to a third embodiment of this invention. As shown in FIG. 8A, a printing tape 51 is made up of: a print-recording layer 53 having a recording surface on its face; a release tape layer 56 which is adhered to a back of the print-recording layer 53; and a transparent pseudo-laminating layer 57 which is adhered to a back of the release tape layer 56. The print-recording layer 53 has a recording tape layer 54 on its face and a general-purpose adhesive-agent layer 55 on its back, and the pseudo-laminating layer 57 has a laminating adhesive-agent layer 58 on its face and a transparent tape layer 59 on its back, respectively. The release tape layer 56 is constituted, like in the second embodiment, by a piece of paper of fine quality whose surface is subjected to silicone coating.

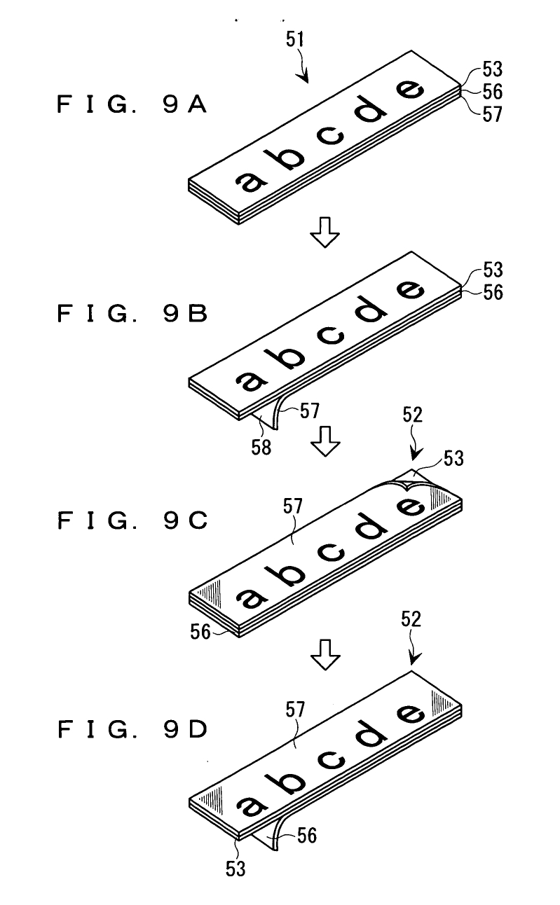

A description will now be made, with reference to FIGS. 9A through 9D, about the procedure for preparing a laminated printing tape by using the printing tape 51 of the third embodiment. The illustrated printing tape 51 has a character string “abcde” printed by the printing head 12 on the face of the print-recording layer 53 and is cut to a desired length by means of a cutter (FIG. 9A). The printing tape 51 having printed thereon a desired image is then subjected to peeling of the pseudo-laminating layer 57 off from the release tape layer 56 (FIG. 9B). Thereafter, the peeled-off pseudo-laminating layer 57 is reversed upside down so that the pseudo-laminating layer 57 looks down, and is then adhered, while keeping it in position, to the face of the print-recording layer 53 (FIG. 9C). As a result, the face of the print-recording layer 53, i.e., the recording surface having printed thereon the character string “abcde,” is laminated by the pseudo-laminating layer 57. Further, by peeling the release tape layer 56 off from the print-recording layer 53 (FIG. 9D), there will be exposed the general-purpose adhesive-agent layer 55 which is provided on the back of the print-recording layer 53. The printing tape 51 can thus be adhered to an object, like an ordinary tape label. Preferably, the adhesive force of the release tape layer 56 to the laminating adhesive-agent layer 58 is smaller than the adhesive force of the release tape layer 56 to the general-purpose adhesive-agent layer 55 so that the pseudo-laminating layer 57 can preferentially be peeled off.

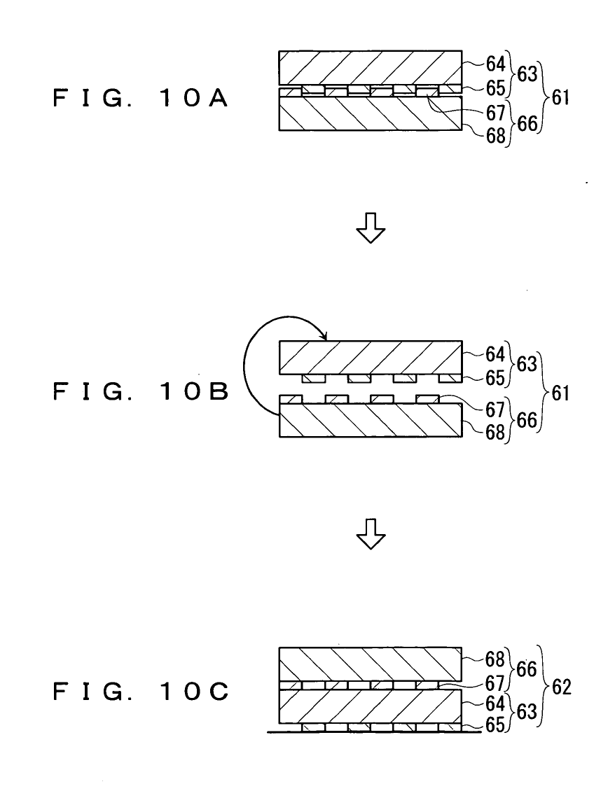

A description will now be made about the printing tape according to a fourth embodiment of this invention. As shown in FIG. 10A, a printing tape 61 has a print-recording layer 63 having a recording surface on a face thereof, and a transparent pseudo-laminating layer 66 which is adhered to a back of the print-recording layer 63. The print-recording layer 63 has a recording tape layer 64 on the face thereof and a general-purpose adhesive-agent layer 65 on a back thereof. The pseudo-laminating layer 66 has a laminating adhesive-agent layer 67 on a face thereof and a transparent tape layer 68 on the back thereof, respectively.

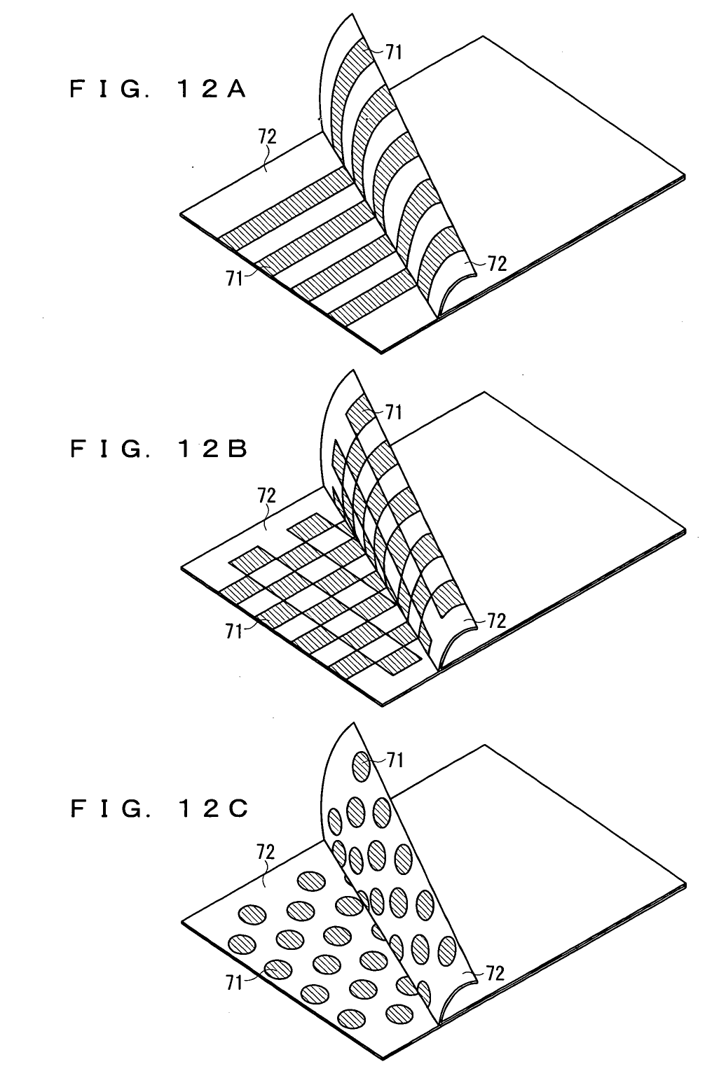

As shown in FIGS. 12A through 12C, the general-purpose adhesive-agent layer 65 and the laminating adhesive-agent layer 67 have a plurality of adhesive-agent coated portions 71 and a plurality of adhesive-agent coating-free portions 72, both portions being alternately disposed on the plane of the tape. The respective adhesive-agent coated portions 71 and the adhesive-agent coating-free portions 72 are formed in a complementary relationship with each other. In the example shown in FIG. 12A, the adhesive-agent coated portions 71 and the adhesive-agent coating-free portions 72 are formed in a band shape so as to be continuous in the longitudinal direction of the tape. In the example shown in FIG. 12B, the adhesive-agent coated portions 71 and the adhesive-agent coating-free portions 72 are formed in a lattice shape. In the example shown in FIG. 12C, independent circular adhesive-agent coated portions 71 are formed in several rows at a distance from each other. In at least part of the widthwise both end portions of the tape, there are formed adhesive-agent coating-free portions 72 in which the adhesive agent is not coated. According to this arrangement, even in case the general-purpose adhesive-agent layer 65 and the laminating adhesive-agent layer 67 are continuously laminated together, the adhesive-agent coated portions 71 and the adhesive-agent coating-free portions 72 alternately disposed on the plane of the tape make it possible to peel the print-recording layer 63 and the pseudo-laminating layer 66 off from each other. In addition, both the adhesive-agent layers 65, 67 do not come into direct contact with each other, thereby preventing the adhesive-agent layers from being damaged.

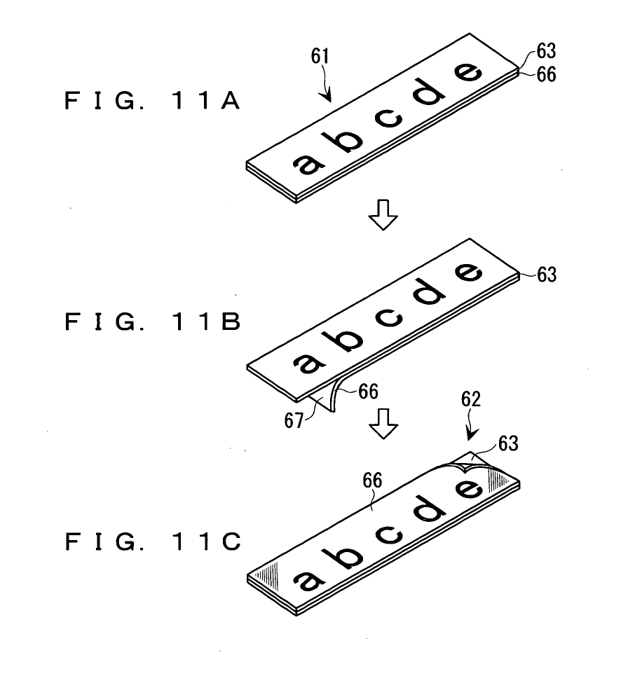

A description will now be made about the procedure for preparing the laminated printing tape 62 by using the printing tape 61 according to the fourth embodiment. A character string of “abcde” is printed by the printing head 12 on the face of the print-recording layer 63, and the printing tape 61 is cut to a desired length (FIG. 11A). The pseudo-laminating layer 66 is peeled off from the print-recording layer 63 (FIG. 11B). The peeled pseudo-laminating layer 66 is turned upside down and, in a state in which the pseudo-laminating layer 66 looks down (as seen in the figure) is adhered to the face of the print-recording layer 63 while keeping it in position (FIG. 11C). The face of the print-recording layer 63, i.e., the recording surface on which the character string “abcde” is printed is thus laminated by the pseudo-laminating layer 66. Since the printing tape 61 of this invention is not provided with the release tape layer the general-purpose adhesive-agent layer 65 provided on the back of the print-recording layer 63 is exposed. As a result, when the printing tape is adhered to an object like in the ordinary tape label, the user can save the trouble of peeling off the release paper.

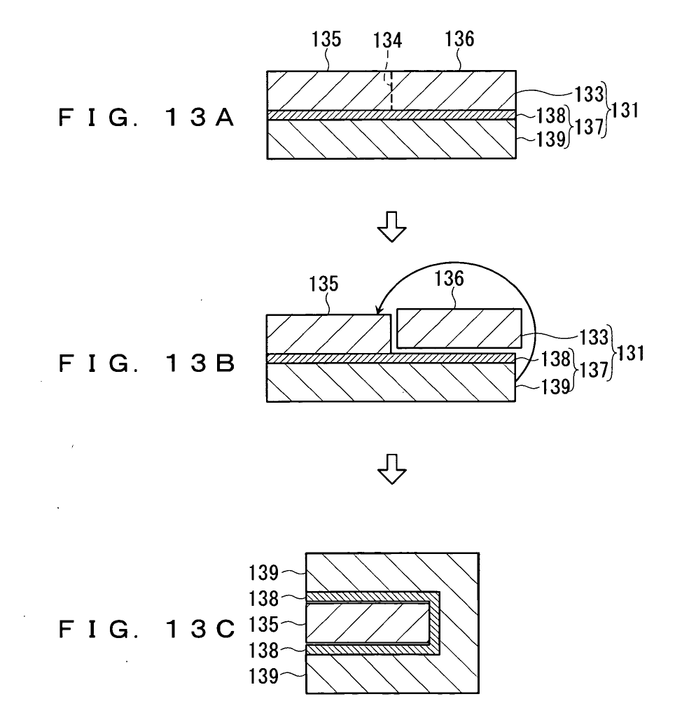

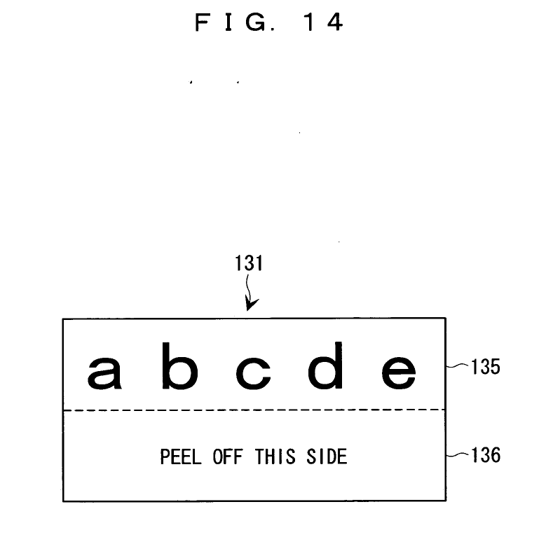

A description will now be made about a printing tape according to a fifth embodiment of this invention. As shown in FIG. 13A, a printing tape 131 is made up of: a print-recording layer 133 whose face serves as a recording surface; and a transparent pseudo-laminating layer 137 which is adhered to a back of the print-recording layer 133. The print-recording layer 133 has formed therein a cutting line 134 along the substantially central position as seen in the widthwise direction of the tape. By means of this cutting line 134, the print-recording layer 133 is arranged to be separable into two pieces extending in the longitudinal direction of the tape, one being a print-recording piece 135 which forms substantially one of the halves, and the other being a cut-off piece 136 which forms substantially the other of the halves. The cut-off piece 136 has printed thereon an operating instruction to the effect that the cut-off piece 136 shall be peeled off in preference to the print-recording piece 135 (FIG. 14). In this manner, the wrong peeling off (i.e., wrongly peeling off the print-recording piece 135 before the cut-off piece 136) can be prevented. The pseudo-laminating adhesive-agent layer 137 is provided, on the face thereof, with a laminating adhesive-agent layer 138, and a transparent tape layer 139 on the back thereof.

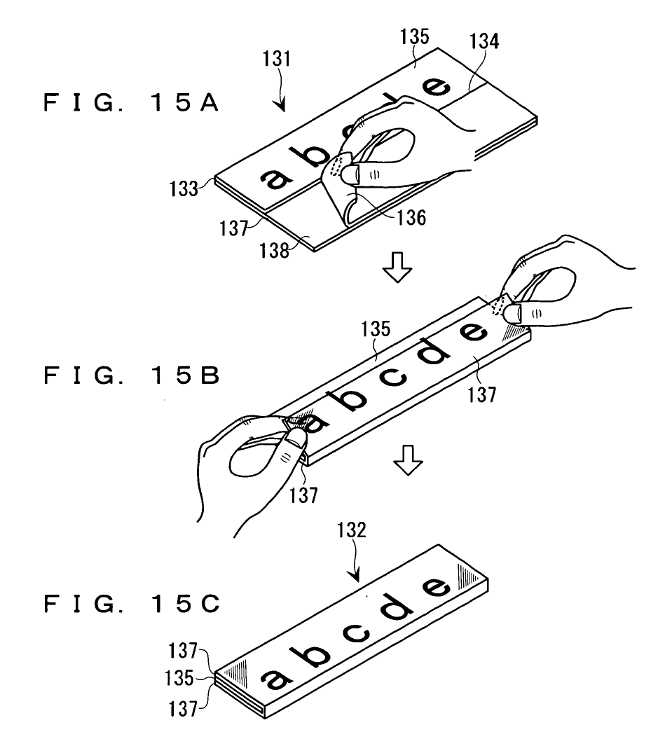

The print-recording layer 133 and the transparent pseudo-laminating layer 137 are respectively made of a thin tape material such as PET or the like. The face of the print-recording layer 133 is subjected to a coating processing in preparing a recording surface in order to improve the stay of the ink. The width of the print-recording piece 135 may be made slightly smaller than the width of the cut-off piece 136. According to this arrangement, that portion of the pseudo-laminating layer 137 which lies on the side of the cut-off piece 136 slightly protrudes beyond the print-recording piece 135 when folded, whereby the laminated printing tape 132 (FIG. 15C) can be temporarily adhered to the object by means of the adhesive-agent layer 138.

That left half (as seen in FIG. 13A) in the widthwise direction of the print-recording tape layer 133 which forms the print-recording piece 135, and the right half (as seen in FIG. 13A) which forms the cut-off piece 136 have no difference in the material and structure, hence they are exchangeable. In other words, the illustrated widthwise left half of the print-recording layer 133 may be made as the cut-off piece 136, and the illustrated widthwise right half may be made as the print-recording piece 135. Therefore, when the tape upper part (as seen in the figure) is made to serve as the adhesive portion in case the laminated printing tape 132 is temporarily adhered, the widthwise right half of the print-recording layer 133 may be made the print-recording piece 135 and the left half may be made as the cut-off piece 136. On the other hand, when the tape lower part is made to serve as the adhesive portion, the widthwise left half of the print-recording layer 133 may be made the cut-off piece 136 and the right half may be made as the print-recording piece 135. In this case, the above-described operating instruction may be printed simultaneously with the printing of the character string “abcde.” It is also possible to arrange that the user operates the input screen so that he/she can designate which of the halves is made to serve as the print-recording piece 135 and which is made to serve as the cut-off piece 136. Although not illustrated, the printing tapes of different widths are made available.

The laminating adhesive-agent layer 138 is provided with adhesive-agent coated portions which are coated with the adhesive agent and adhesive-agent coating-free portions which are not coated with the adhesive agent in the same manner as in the above-described fourth embodiment. Therefore, detailed description thereof is omitted.

A description will now be made, with reference to FIGS. 15A through 15C, about the procedure for preparing the laminated printing tape 132 by using the printing tape 131 according to the fifth embodiment. The printing tape 131 in FIG. 15A has a character string “abcde” printed on the face of the print-recording piece 135 of the print-recording layer 133, and the printed portion is cut to a desired length. As shown in FIG. 1, the cartridge mounting block 7 has at its corner cartridge detection switches 19. When a tape cartridge 6 is mounted or loaded, the kind of the printing tape 10 is detected. In other words, when the tape cartridge 6 is mounted, a detection is made that the printing tape is the one for use in the fifth embodiment of this invention. The control block drives the printing head 12 to thereby print the character string “abcde” on substantially the half of the print-recording layer 133, i.e., on the print-recording piece 135. The print-recording tape 131 thus having printed thereon the character string is first subjected to the peeling operation of the substantially half of the print-recording layer 133, i.e., the cut-off piece 136, off from the pseudo-laminating layer 137. The cut-off piece 136 is cut off along the cutting line 134 which is formed on the surface of the print-recording layer 133 (FIG. 15A). Then, that side portion of the pseudo-laminating layer 137 which lies on the cut-off piece 136 is folded over (or onto) the face of the print-recording piece 135 and is adhered (FIG. 15B). According to this operation, the face of the print-recording piece 135, i.e., the recording surface on which the character string of “abcde” is printed, is laminated by the pseudo-laminating layer 137 (FIG. 15C). As described above, the printing tape 131 of this embodiment is arranged to be adhered by folding the pseudo-laminating layer 137. Therefore, the positioning or alignment is easy and, as a consequence, the deviation or distortion in positioning of the pseudo-laminating layer 137 is kept to a minimum.

If that folding position of the pseudo-laminating layer 137 which lies on the side of the cut-off piece 136 is moved right or left as seen in the figure (i.e., in the widthwise direction of the tape), the width of the laminated printing tape 132 can be adjusted so as to become slightly larger or smaller. For example, suppose a laminated printing tape 132 of 12 mm in width is used to make a laminated printing tape 132. If the position of the cutting line 134 in the print-recording layer falls on the folding position, there will be formed a laminated printing tape 132 whose width is 6 mm. If the folding position is moved to the right as seen in the figure from the cutting line 134 by 1 mm before folding, there can be obtained a laminated printing tape 132 whose width is 7 mm. On the other hand, if the folding position is moved to the left as seen in the figure from the cutting line 134 by 1 mm before folding, there will be a portion equivalent to 2 mm in which the laminating adhesive-agent layer 138 remains exposed. If this portion is then folded to the back of the print-recording layer 133, there can be obtained a laminated printing tape 132 whose width is 5 mm. In this manner, by moving the folding position left or right as seen in the figure in the widthwise direction of the tape, the width of the laminated printing tape 132 can be slightly adjusted, whereby the tape can be adhered to an object in a better aesthetical manner. An arrangement may be made such that an auxiliary line is printed in advance on the recording surface of the print-recording layer 133 in a position which coincides with the folding position.

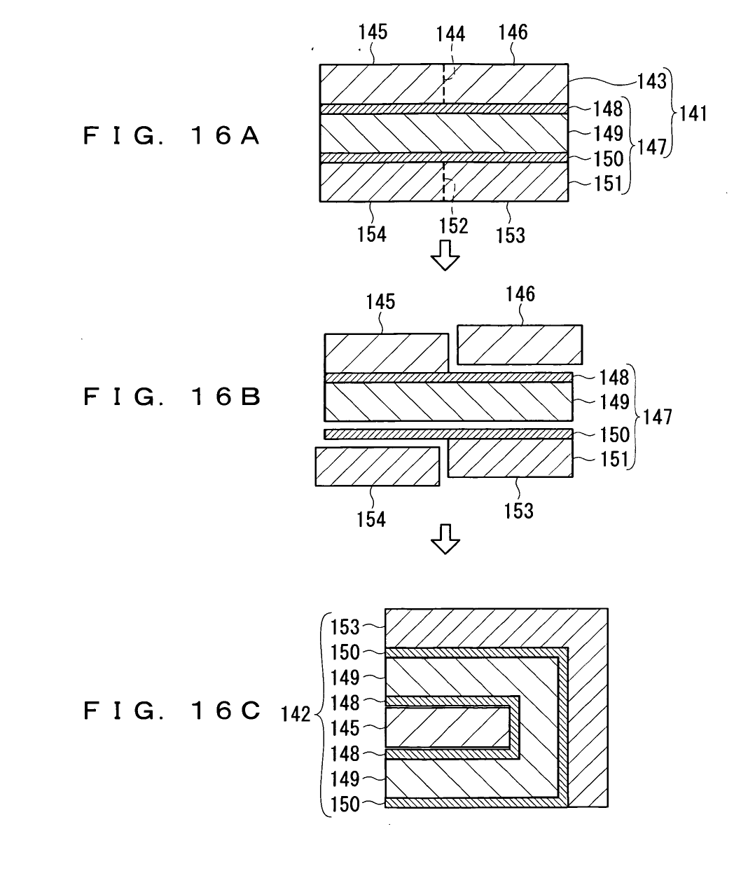

A description will now be made about a printing tape 141 according to a sixth embodiment of this invention, which is made by adding a back adhesive agent to the printing tape of the fifth embodiment. As shown in FIG. 16A, the printing tape 141 is made up of: a print-recording layer 143 whose face serves as a recording surface; and a transparent pseudo-laminating layer 147 which is adhered to a back of the print-recording layer 143. On the face of the print-recording layer 143, there is formed a cutting line 144 substantially in the widthwise center of the tape so as to extend in the longitudinal direction of the tape. By means of this cutting line 144, the print-recording layer 143 is arranged to be separable into two pieces, one being a print-recording piece 145 which forms substantially one of the halves, and the other being a cut-off piece 146 which forms substantially the other of the halves. The pseudo-laminating adhesive-agent layer 147 is made up, in the order as seen from the face downward, of a laminating adhesive-agent layer 148, a first transparent tape layer 149, a general-purpose adhesive-agent layer 150 and a second transparent tape layer 151. On the rear of the second transparent tape layer 151, there is also provided a cutting line 152 substantially in the widthwise center of the tape so as to extend along the longitudinal direction of the tape. It is thus so arranged that this cutting line 152 enables the second transparent tape layer 151 to be cut apart into a transparent tape piece 153 which becomes one of the two halves and a release piece 154 which is the other of the two halve.

Like the fifth embodiment, the print-recording layer 143 and the pseudo-laminating layer 147 of the sixth embodiment are made of a thin tape material such as PET or the like. The face of the print-recording layer 143 is subjected to a coating processing in preparing a recording surface so as to improve the stay of the ink. The release piece 154 has printed thereon an operating instruction to the effect that the release piece 154 shall be peeled off in preference to the transparent tape piece 153. According to this arrangement, the laminating adhesive-agent layer 148 is provided with adhesive-agent coated portions which are coated with the adhesive agent and adhesive-agent coating-free portions which are not coated with the adhesive agent in the same manner as in the above-described fourth embodiment. Therefore, detailed description thereof is omitted. Further, like in the fifth embodiment, the left half as seen in the figure which serves as the print-recording piece 145 and the right half as seen in the figure which serves as the cut-off piece 146 are not different from each other in material and construction and are, therefore, interchangeable.

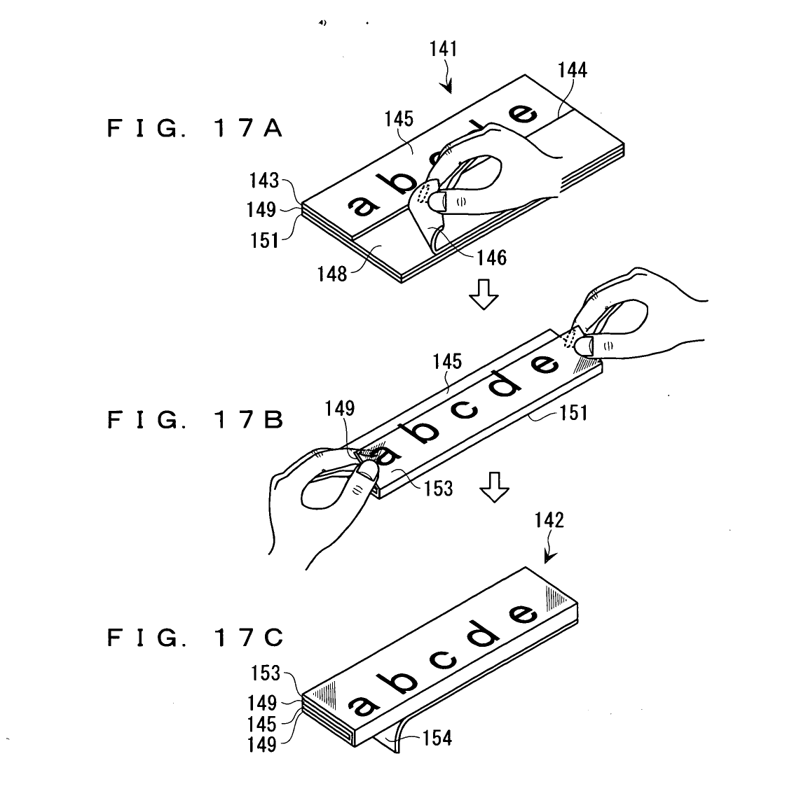

A description will now be made, with reference to FIGS. 17A-17C, about the procedure for preparing the laminated printing tape 142 by using the printing tape 141 according to the sixth embodiment of this invention. The printing tape 141 has a character string “abcde” printed on the face of the print-recording piece 145 of the print-recording layer 143, and the printed portion is cut to a desired length. In the printing tape 141 having printed thereon the character string, the substantial half which serves as the cut-off piece 146 of the print-recording layer 143 is first peeled off from the pseudo-laminating layer 147 to thereby separate the cut-off piece 146 along the cutting line 144 which is formed on the surface of the print-recording layer 143 (FIG. 17A). Then, that portion of the first transparent tape layer 149 which lies on the side of the cut-off piece 146, and the transparent tape piece 153 are folded over (or onto) the face of the print-recording piece 145 and gets adhered thereto (FIG. 17B). According to this operation, the face of the print-recording piece 145, i.e., the recording surface on which the character string “abcde” has been printed, is laminated by the pseudo-laminating layer 147 (FIG. 17C). In this case, since the pseudo-laminating layer 147 is folded at the time of adhesion, the positioning is easy and, therefore, the deviation and distortion in positioning can be kept to a minimum. Furthermore, by cutting off the release piece 154 along the cutting line 152 which is formed on the back of the second transparent tape 151, the general-purpose adhesive-agent layer 150 is exposed. The laminated printing tape 142 can thus be adhered to an object of adhesion. In this case, the above-described operation manual may be printed simultaneously with the printing of the character string “abcde.”

It is further understood by those skilled in the art that the foregoing is the preferred embodiments of the invention, and that various changes and modifications may be made without departing from the spirit and scope thereof.

What is claimed is:

1. A printing tape comprising:
a print-recording layer having a recording surface on a face thereof; and
a transparent pseudo-laminating layer adhered to a back of said print-recording layer,
said pseudo-laminating layer having a laminating adhesive-agent layer on a face thereof and a transparent tape layer on a back thereof, and being so arrange that said pseudo-laminating layer is reversed for adhesion to the face of said print-recording layer, thereby serving as a laminating tape for the recording surface.

2. A printing tape comprising:
a print-recording layer having a recording surface on a face thereof;
a transparent pseudo-laminating layer adhered to a back of said print-recording layer; and
a release tape layer adhered to a back of said pseudo-laminating layer,
said print-recording layer having a recording tape layer on the face thereof and a general-purpose adhesive-agent layer on a back thereof,
said pseudo-laminating layer having a transparent tape layer on a face thereof and a laminating adhesive-agent layer on a back thereof, and being so arranged that said release tape layer is released for adhesion of said pseudo-laminating layer to the face of said recording tape layer, thereby serving as a laminating tape for the recording surface.

3. A printing tape comprising:
a print-recording layer having a recording surface on a face thereof;
a release tape layer adhered to a back of said print-recording layer; and
a transparent pseudo-laminating layer adhered to a back of said release tape layer,
said print-recording layer having a recording tape layer on the face thereof and a general-purpose adhesive-agent layer on the back thereof,
said pseudo-laminating layer having a laminating adhesive-agent layer on the face thereof and a transparent tape layer on a back thereof, and being so arrange that, upon peeling of said release tape layer, said pseudo-laminating layer is reversed for adhesion to the face of said print-recording layer, thereby serving as a laminating tape for the recording surface.

4. A printing tape comprising:
a print-recording layer having a recording surface on a face thereof;
a transparent pseudo-laminating layer adhered to a back of said print-recording layer,
said print-recording layer having a recording tape layer on the face thereof and a general-purpose adhesive-agent layer on a back thereof,
said pseudo-laminating layer having a laminating adhesive-agent layer on a face thereof and a transparent tape layer on the back thereof, and being so arrange that said pseudo-laminating layer is reversed for adhesion to the face of said print-recording layer, thereby serving as a laminating tape for the recording surface,
said general-purpose adhesive-agent layer and said laminating adhesive-agent layer respectively having a plurality of adhesive-agent coated portions and a plurality of adhesive-agent coating-free portions alternately disposed in a complimentary relationship with each other.

5. A printing tape comprising:
a print-recording layer having a recording surface on a face thereof;
a transparent pseudo-laminating layer adhered to a back of said print-recording layer,
said print-recording layer having a cutting line formed substantially along a widthwise center of the printing tape so as to form two longitudinally extending halves, one of the halves forming a print-recording piece having said recording surface on the face and the other of the halves forming a cut-off piece,
said pseudo-laminating layer having a laminating adhesive-agent layer on a face thereof and a transparent tape layer on a back thereof, and being so arranged that a substantial half, corresponding to a side of the cut-off piece, of said pseudo-laminating layer is folded for adhering onto the face of the print-recording piece upon removal of the cut-off piece, thereby serving as a laminating tape for the recording surface.

6. A printing tape comprising:
a print-recording layer having a recording surface on a face thereof;
a transparent pseudo-laminating layer adhered to a back of said print-recording layer,
said print-recording layer having a cutting line formed substantially along a widthwise center of the printing tape so as to form two longitudinally extending halves, one of the halves forming a print-recording piece having a recording surface on the face and the other of the halves forming a cut-off piece,
said pseudo-laminating layer having, as seen from the face side, a laminating adhesive-agent layer, a first transparent tape layer, a general-purpose adhesive-agent layer, and a second transparent tape layer,
said second transparent tape layer having a cutting line formed substantially along a widthwise center thereof so as to form two longitudinally extending halves, one of the halves forming a transparent tape piece and the other of the halves forming a release piece, and being so arranged that a substantial half, corresponding to a side of the cut-off piece, of said first transparent tape layer and the transparent tape piece are folded, upon removal of the cut-off piece and the release piece, for adhering onto the face of the print-recording piece, thereby serving as a laminating tape for the recording surface.

7. The printing tape according to claim 1, wherein said laminating adhesive-agent layer has an adhesive-agent coated portion and an adhesive-agent coating-free portion disposed on a tape surface, and wherein the adhesive-agent coating-free portion is formed in at least a part of both widthwise end portions of the printing tape.

8. The printing tape according to claim 7, wherein the adhesive-agent coating-free portion is constituted by a plurality of longitudinally extending band portions which are parallel with a longitudinal direction of the printing tape, inclusive of widthwise both end portions thereof.

9. The printing tape according to claim 7, wherein the adhesive-agent coating-free portion is constituted by a plurality of inclined band portions which are inclined to the longitudinal direction of the printing tape and which are parallel with each other.

10. The printing tape according to claim 7, wherein the adhesive-agent coating-free portion is constituted by a plurality of bands which are parallel with each other in the widthwise direction of the printing tape.

11. The printing tape according to claim 7, wherein the adhesive-agent coating-free portion is constituted by a plurality of isolated portions dispersed in a scattered manner.

12. The printing tape according to claim 4, wherein at least part of the adhesive-agent coated portions located at widthwise both end portions of said general-purpose adhesive-agent layer and said laminating adhesive-agent layer is omitted.

13. The printing tape according to claim 5, wherein the print-recording piece is formed slightly smaller in width than the cut-off piece.

14. The printing tape according to claim 5, wherein the cut-of piece has printed thereon an operating instruction.

15. The printing tape according to claim 6, wherein the release piece has printed thereon an operating instruction.

16. The printing tape according to claim 6, wherein said general-purpose adhesive-agent layer has an adhesive-agent coated portion and an adhesive-agent coating-free portion,
said adhesive-agent coating-free portion being formed in at least part of widthwise end portions of the printing tape.

17. A tape cartridge comprising the printing tape according to any one of claims 1 through 6 in a rolled state, and a cartridge case for containing therein the printing tape in a manner to be freely pulled out.
